(19) United States
(12) Patent Application Publication
(10) Pub. No.: US 2006/0083843 A1
(43) Pub. Date: Apr. 20, 2006

(54) Doughless pizza and method of making same

(76) Inventor: Lorenzo G. Sommaggio, Cape Coral, FL (US)

Correspondence Address: EDWARD M. LIVINGSTON, PA, 963 TRAIL TERRACE DRIVE, NAPLES, FL, 34103, US

(21) Appl. No.: 10/970,179

(22) Filed: Oct. 20, 2004

(51) Int. Cl. A23C 19/00

(52) U.S. Cl. 426/582

(57) ABSTRACT

A doughless pizza and method of making same wherein the doughless pizza utilizers a container (1), rather than a crust, to keep traditional pizza ingredients intact. To make the present invention, a user selects a container (5), adds a predetermined amount of pizza sauce to the container (6) and adds a predetermined amount of cheese on top of the pizza sauce (7) to create a cheese layer. A user may then optionally add additional toppings (8) to the cheese layer. Then, the user places the container with the ingredients into a cooking device (9), which is preferably an oven, and cooks the container with the ingredients for a predetermined amount of time at a predetermined temperature (10). The user then removes the container with the ingredients from the cooking device (11) and may either begin eating (13) or allow the container with the ingredients to cool (12) and then proceed to eat (13).

### BACKGROUND OF THE INVENTION

This invention relates to pizzas, more specifically, a doughless pizza and method of making same that allows carbohydrate conscious individuals to enjoy pizza without the guilt.

Although bread and bread products have always been a staple food, many individuals believe that the consumption of carbohydrates, such as those found in bread and bread products, leads to weight gain. In order to lose weight and keep it off, many individuals have become “carb-conscious” whereby he or she severely limits or even eliminates bread from his or her diet. Although the individual may lose and keep the weight off, he or she is not able to enjoy one of the most popular foods around the world: pizza.

Although pizzas can vary between toppings, whether or not it will have pizza sauce and/or cheese, there is one constant: the dough. The dough, which forms the crust of the pizza upon cooking, is the base of the pizza and holds all of the toppings together. Thus, carbohydrate conscious individuals are not able to enjoy a pizza because the crust contains a large amount of carbohydrates.

Thus, the need exists for a carbohydrate-friendly pizza wherein no dough is used.

The relevant prior art includes the following patents:

| Patent No. | | |
|---|---|---|
| (U.S. unless stated otherwise) | Inventor | Issue Date |
| 3,615,690 | Lisle et al. | 10-26-1971 |
| 5,256,432 | McDonald et al. | 10-26-1993 |
| 6,753,025 | Tippmann | 06-22-2004 |
| 5,023,096 | Plochman | 06-11-1991 |
| JP 358081738 A | Ono | 05-17-1983 |
| 6,235,321 | Kerrigan et al. | 05-22-2001 |
| 5,939,113 | Hursh | 08-17-1999 |
| 5,243,899 | Moshier et al. | 09-14-1993 |

### SUMMARY OF THE INVENTION

The primary object of the present invention is to provide a pizza that does not have a crust.

A further object of the present invention is to provide a pizza that is low in carbohydrates.

An even further object of the present invention is to provide a pizza that tastes good.

A further object of the present invention is to provide a method for making pizza that is easy to perform.

An even further object of the present invention is to provide a method for making pizza that allows a person to make the pizza quickly.

The present invention fulfills the above and other objects by providing a pizza comprised of at least two ingredients: pizza sauce and cheese. Additional toppings, such as pepperoni, sausage, other meats, green peppers, black olives and other vegetable, may also be included to cater the pizza to an individual's liking.

To make the present invention, a user first selects a container having a base and side walls. The container can be of any size, depth or shape and is preferably made of material which can withstand high temperatures, such as a pan. Then, the user first pours a predetermined amount of pizza sauce into the base of the container so as to create a layer of pizza sauce. Next, the user adds a predetermined quantity of cheese. The user may then add additional toppings, such as meats or vegetables, on top of the cheese. Finally, the user inserts the container containing the ingredients into a cooking device, such as an oven, a cooks the container containing the ingredients for a predetermined amount of time at a predetermined temperature. When finished cooking, the user removes the doughless pizza and allows it to cool slightly. Upon cooling, the doughless pizza becomes thicker so as to permit the user to eat the doughless pizza with a fork.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side plan view the present invention; and

FIG. 2 is a flow diagram representing the steps for making the present invention.

### DESCRIPTION OF THE PREFERRED EMBODIMENTS

For purposes of describing the preferred embodiment, the terminology used in reference to the numbered components in the drawings is as follows:
1. container
2. sauce
3. cheese
4. toppings
5. select container
6. add predetermined amount of pizza sauce to container
7. add predetermined amount of cheese on top of sauce
8. add additional toppings
9. place container with ingredients in cooking device
10. cook for a predetermined amount of time
11. remove container from cooking device
12. allow to cool
13. eat

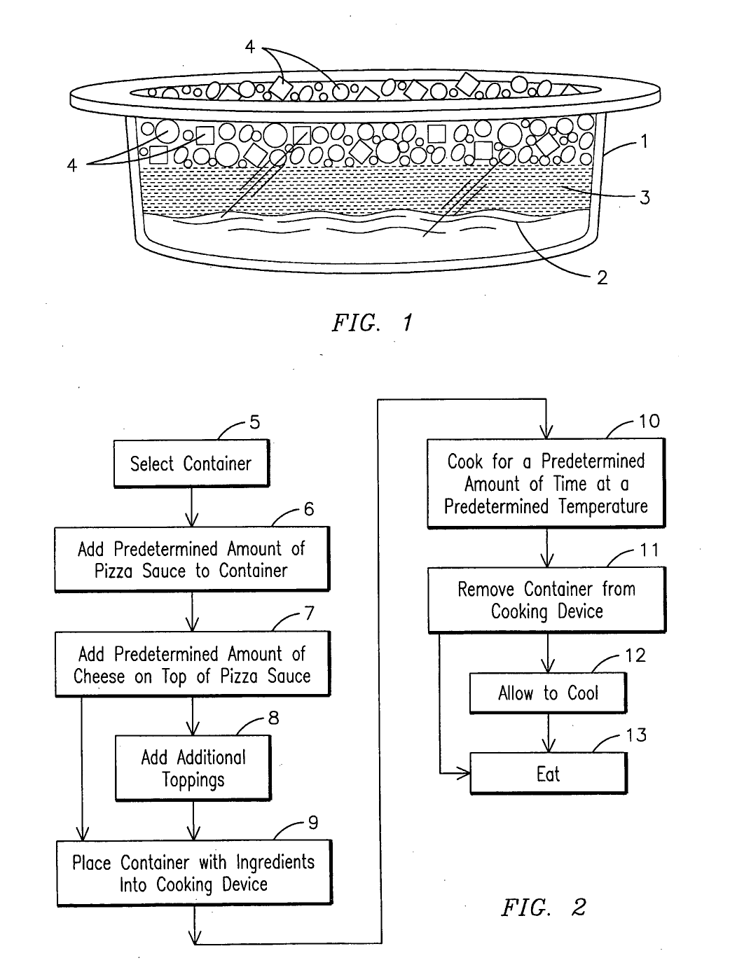

With reference to FIG. 1, a plan view of the present invention is shown. The doughless pizza has at least sauce 2, which is preferably pizza sauce, and cheese 3, but may also include additional toppings 4. Rather than having a crust as a base, the doughless pizza is contained in a container 1. The container 1 is preferably deep so as to contain a large amount of ingredients, although a shallow container may be used so as to contain a small amount of ingredients. In addition, the size of the container may vary according to a user's appetite. The container 1 may be reusable or disposable and is preferably made of a material which may withstand high temperatures.

With reference to FIG. 2, a flow diagram representing the steps for making the present invention is shown. First, a user selects a container 5. Next, he or she adds a predetermined amount of pizza sauce to the container 6. The amount of pizza sauce may vary according to the user's preference. Then, the user adds a predetermined amount of cheese, preferably cheese which has been shredded, on top of the pizza sauce 7 to create a cheese layer. Once again, the amount of cheese and type of cheese added, including mozzarella cheese or other cheese blends, may vary according to the user's preference. A user may then optionally add additional toppings 8 to the cheese layer, although this step is only a matter of user preference. Then, the user places the container with the ingredients into a cooking device 9, which is preferably an oven. Although it is preferable to use an oven, a microwave oven, a grill, a toaster oven or any other type of heating unit may also be used. The user then cooks the container with the ingredients for a predetermined amount of time at a predetermined temperature 10. The preferable cooking time is between five to seven minutes and the preferable cooking temperature is 500 degrees Fahrenheit. The user then removes the container with the ingredients from the cooking device 11 and may either begin eating 13 or allow the container with the ingredients to cool 12 and then proceed to eat 13. Preferably, the user will allow the container with the ingredients to cool 12 before eating 13 as the cheese 3, sauce 2 and toppings 4 will thicken upon cooling to permit a user to eat 13 with a fork. If a user begins eating the present invention without allowing it to cool first, the invention may have a liquid-like consistency so that a user may have to use a spoon to eat it.

It is to be understood that while a certain form of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A doughless pizza comprising:
a predetermined amount of sauce within a container; and
a predetermined amount of cheese on top of said sauce.

2. The doughless pizza of claim 1 further comprising:
a predetermined amount of additional toppings on top of said predetermined amount of cheese.

3. The doughless pizza of claim 1 wherein:
said container is able to withstand high temperatures.

4. The doughless pizza of claim 1 wherein:
said sauce is pizza sauce.

5. The doughless pizza of claim 1 wherein:
said cheese is mozzarella cheese.

6. A method for making a doughless pizza comprising a predetermined amount of sauce within a container; and a predetermined amount of cheese on top of said sauce, said method comprising the steps of:
a. selecting the container;
b. putting a predetermined amount of sauce in the container;
c. adding a predetermined amount of cheese on top of said sauce;
d. placing said container having said predetermined amount of sauce and predetermined amount of cheese on top of said sauce into a cooking device;
e. cooking said container having said predetermined amount of sauce and predetermined amount of cheese on top of said sauce for a predetermined amount of time at a predetermined temperature; and
f. removing said container having said predetermined amount of sauce and predetermined amount of cheese on top of said sauce.

7. The method of claim 6 further comprising the step prior to step d of:
adding additional toppings on top of said predetermined amount of cheese.

8. The method of claim 6 further comprising the step prior to step f of:
allowing said container having said predetermined amount of sauce and predetermined amount of cheese on top of said sauce to cool.

9. The method of claim 7 further comprising the step prior to step f of:
allowing said container having said predetermined amount of sauce and predetermined amount of cheese on top of said sauce to cool.

10. The method of claim 6 wherein:
the predetermined amount of time is between five and seven minutes.

11. The method of claim 6 wherein:
the predetermined temperature is 500 degrees Fahrenheit.

12. The method of claim 10 wherein:
the predetermined temperature is 500 degrees Fahrenheit.
